(19) United States
(12) Patent Application Publication
(10) Pub. No.: US 2010/0066613 A1
(43) Pub. Date: Mar. 18, 2010

(54) Antenna Device

(75) Inventors: Robert Hardacker, Escondido, CA (US); James R. Milne, Ramona, CA (US); Robert A. Unger, El Cajon, CA (US)

Correspondence Address: CROWELL & MORING LLP;INTELLECTUAL PROPERTY GROUP, P.O. BOX 14300, WASHINGTON, DC, 20044-4300, US

(73) Assignee: SONY CORPORATION, Tokyo (JP)

(21) Appl. No.: 12/209,609

(22) Filed: Sep. 12, 2008

(51) Int. Cl. H01Q 1/24; H01Q 1/38

(52) U.S. Cl. 343/702; 343/700 MS

(57) ABSTRACT

An antenna is provided to receive wireless signals for a display device. In one embodiment, the antenna comprises a film comprised of translucent material, wherein the film overlays at least a portion of a viewing area of the display device. The antenna may further include a conductive element for receiving one or more wireless signals, the conductive element embedded in the film within the viewing area of the display device, and a terminal configured to couple the conductive element to one or more terminals of the display device.

### FIELD OF THE INVENTION

The present invention relates in general to antenna structures and more particularly to an antenna device for display devices.

### BACKGROUND

In recent years, use of flat-panel display devices for displaying media and as computer monitors has become mainstream. The commercial success of these flat-panel displays may be attributed in part to advances in display quality and a reduction in package size. Typical display devices for computer monitor applications may be less than an inch in thickness. Similarly, display devices for viewing broadcast media may be only a few inches in thickness. Additionally, current developers aim to minimize packaging surrounding the viewing area of display devices. Thus, the bezels of current display devices continue to be minimized. As a result of the drive to minimize packaging of display devices, placement and capacity for some components may be limited or even eliminated.

Many display devices receive input signals via dedicated terminals, usually located in the rear of the display device. In that fashion, connections to the display device may be hidden from a viewer. However, there exists a need for these display devices to receive data wirelessly. Some display devices have incorporated internal antennas mounted underneath a bezel of the display device. Due to reductions in the packaging of some display devices, housing antennas within a bezel of the display device may no longer be possible. Further, these display devices are typically mounted to, or near, a wall such that antenna placement may limit receiving and transmitting capability of a display device. Therefore, there is a need for an antenna device which overcomes one or more of the aforementioned drawbacks.

### BRIEF SUMMARY OF THE INVENTION

Disclosed and claimed herein is an antenna configured to receive wireless signals for a display device. In one embodiment, an antenna includes a film comprised of translucent material, the film overlaying at least a portion of a viewing area of the display device. The antenna further includes a conductive element for receiving one or more wireless signals, wherein the conductive element is embedded in the film within the viewing area of the display device, and a terminal configured to couple the conductive element to one or more terminals of the display device.

Other aspects, features, and techniques of the invention will be apparent to one skilled in the relevant art in view of the following detailed description of the invention.

### BRIEF DESCRIPTION OF THE DRAWINGS

FIG. 1 depicts a display device comprising an antenna according to one embodiment of the invention;

FIG. 2 depicts a simplified system diagram according to one or more embodiment of the invention;

FIGS. 3A-3C depict antennas according to one or more embodiments of the invention; and

FIGS. 4A-4C depict graphical representations of antennas according to one or more embodiments of the invention.

### DETAILED DESCRIPTION OF EXEMPLARY EMBODIMENTS

The present disclosure relates generally to an antenna and more particularly to an antenna which may be used for receiving and/or transmitting data for a display device. As will be described in more detail below, one or more arrangements may be provided for an antenna which may be used with a display device. According to one embodiment, the antenna may be fixed to a viewing area of a display device. According to another embodiment, the antenna may be fixed to an outer portion of a display device. The antenna may comprise a film configured to support one or more conductive elements. The film may be comprised of translucent material to allow for placement of the antenna in the viewing area of a display device without affecting viewing of a user according to another embodiment. The antenna may be coupled to an outer surface of the display device such as the bezel. Further, placement of the antenna can allow for improved signal gain. In certain embodiments, the antenna may relate to a thin film antenna structure. It may also be appreciated that one or more antennas may be utilized for a single display device.

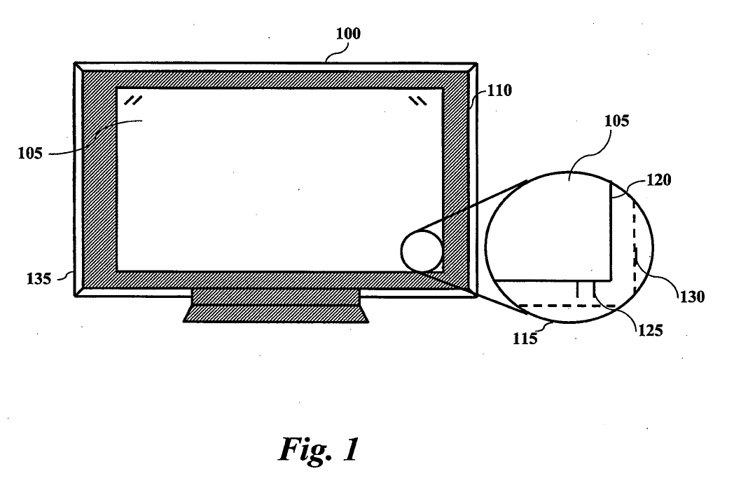

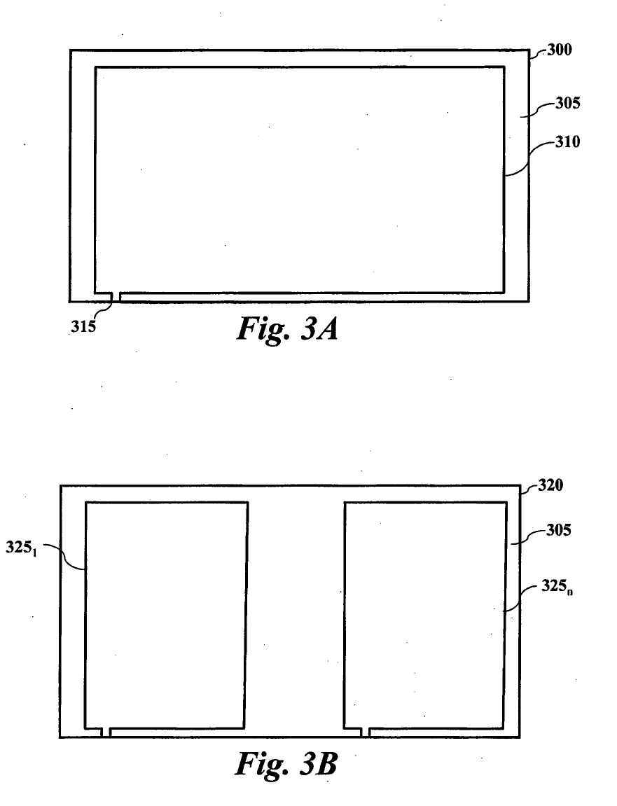

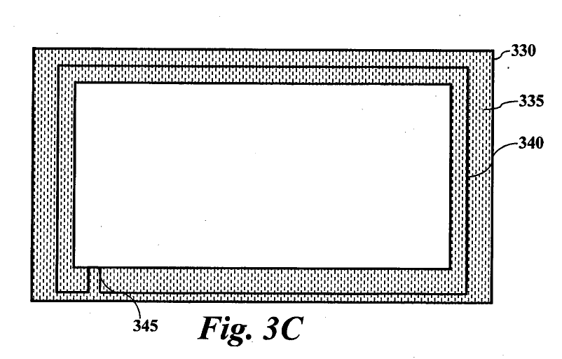

Referring now to the drawings, FIG. 1 is a graphical representation of a display device comprising an antenna according to one embodiment of the invention. As shown in FIG. 1, display device 100 includes viewing area 105 and bezel 110. According to one embodiment, an antenna may be applied to viewing area 105 of display 100. As shown in FIG. 1, window 115 provides a revealed view of antenna 120 coupled to the viewing area of display device 100. Antenna 120 may comprise a thin-film antenna. Additionally, antenna 120 may be electrically coupled to the display device by terminal 125. Details of antenna 120 will be described in more detail below with regard to FIGS. 3A-3C. As shown in revealed view 115, a border of bezel 110 is shown by reference number 130. According to another embodiment, display device 100 may relate to one or more of a television, monitor, computer display and display device in general. In a further embodiment, antenna 120 may be coupled to display device 100 by electrostatic attraction or an adhesive.

In one embodiment of the invention, antenna 120 may be overlaid on viewing area 105 of display device 100 to receive one or more signals. One advantage of coupling antenna 120 to viewing area 105 of display device 100 may be improved signal response. According to another embodiment, antenna 120 may be coupled to bezel 110 of display device 100. In certain embodiments, antenna 120 may be coupled to a frame of display device 100. By way of example, display device 100 includes frame 135 surrounding bezel 110. Frame 135 may be included as a visual accent, for aesthetic qualities and/or functional qualities. In one embodiment, antenna 120 may be coupled to frame 135 as will be described in more detail below with respect to FIG. 3C. Frame 135 may relate to one of glass, plastic, metal, etc. According to another embodiment, display device 100 may be configured to support a plurality of antennas. As such, it may be appreciated that a plurality of antennas may be coupled to viewing area 105, bezel 110 and/or frame 135.

According to one embodiment, antenna 120 may be coupled to display device 100 during manufacturing. Alternatively, antenna 120 may be coupled to display device 100 following the manufacturing process. Antenna 120 may comprise translucent material configured to allow for a visibility range of at least seventy percent transmittance of the displayed image data. In that fashion, antenna 120 can overlay the viewing area and permit normal viewing. Further, a translucent material may be selected which does not distort displayed images of the display device. It may also be appreciated that other ranges and/or values of visibility may be employed for components of antenna 120. To that end, antenna 120 may be coupled to display device 100 and still allow for normal viewing of the display device.

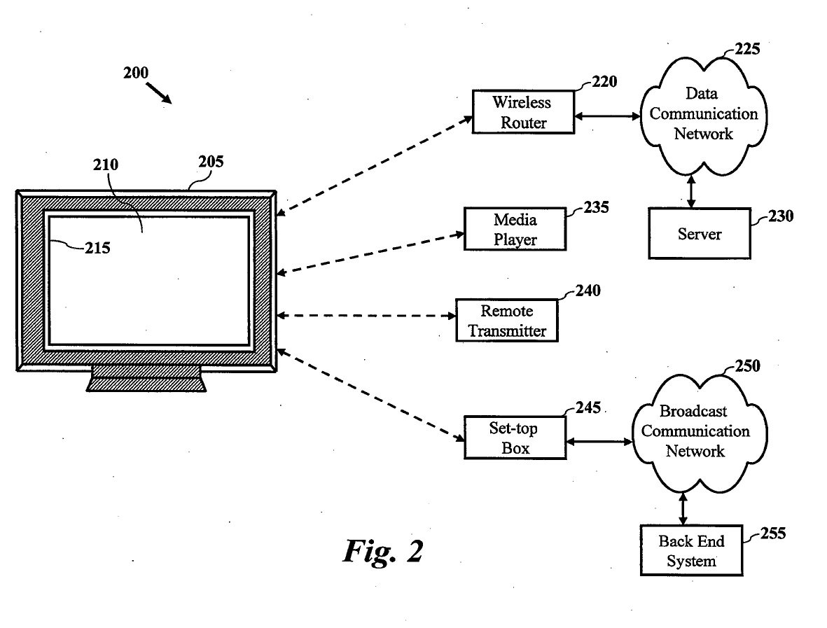

Referring now to FIG. 2, a simplified system diagram is shown of a system according to one or more embodiments. As shown in FIG. 2, system 200 includes a display device 205 (e.g., display device 105) employing antenna 215 (e.g., antenna 120). Antenna 215 is coupled to viewing area 210 of display 205 and configured to receive one or more wireless signals. System 200 may include at least one of wireless router 220, media player 235, remote transmitter 240, and set-top box 245 to transmit wireless data to display device 205. In one embodiment, set-top box 245 may correspond to one of a satellite receiver, television tuner and any television middleware device in general. Antenna 215 may be configured to receive data from wireless router 220 distributed by server 230 over data communication network 225. By way of example, it may be appreciated that antenna 215 may be configured to receive media including audio, video, guide data and data in general. In a similar fashion, antenna 215 may be configured to receive wirelessly-transmitted media data for display device 205 by media player 235.

In one embodiment, one or more wireless commands transmitted by remote transmitter 240 for display device 205 may be received by antenna 215. According to another embodiment, antenna 215 may be configured to receive one or more signals transmitted by set-top box 245. Data transmitted by set-top box 245 may include media received from backend system 255 over broadcast communication network 250. Backend system 255 and broadcast communication network 250 may be used to provide media corresponding to a multitude of forms (e.g., Digital Satellite System (DSS), Digital Broadcast system (DBS), Advanced Television Standards Committee (ATSC), Internet Protocol Television (IPTV), etc.). Communication links shown in FIG. 2 may correspond to radio frequency (RF) links. It may also be appreciated that antennas employed by display device 205 may be configured to transmit one or more signals. Further, antenna 215 may be configured to allow for communication using any of the 802.11x standards.

As shown in FIG. 2, antenna 215 comprises a single conductive element. However, it should be appreciated that antenna 215 may comprise a plurality of conductive elements to provide a plurality of antennas. In one embodiment, multiple antennas may be coupled to viewing area 210 of display device 205. Alternatively, or in combination, display device 205 may be configured to support antennas coupled to a bezel (e.g., bezel 110) or display frame (e.g., glass frame 135). According to another embodiment, an antenna may be mounted to other objects located in close proximity to display device 205. To that end that, system 200 may comprise one or more antennas to receive data for display device 205 according to one embodiment of the invention.

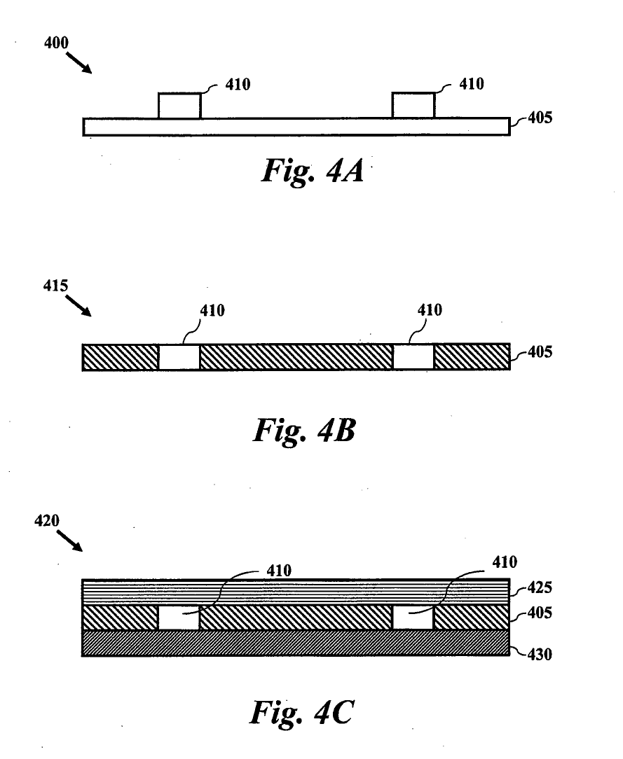

Referring now to FIGS. 3A-3C, graphical representations are shown of antennas according to one or more embodiments of the invention. Referring first to FIG. 3A, antenna 300 is shown according to one embodiment of the invention. As shown in FIG. 3A, antenna 300 includes film 305 and conductive material 310 (e.g., conductive element 215). In one embodiment, film 305 may correspond to a translucent material, such as one or more of synthetic polymer, organic film and glass. It may also be appreciated that film 305 may correspond to other materials. Film 305 may correspond to a translucent material which is not easily noticable by users at a regular viewing distance. It may be appreciated that a viewing distance may be in the range of 1 m to 5 m. It may also be appreciated that antenna 305 be used with other viewing distances. Further, film 305 may relate to a material which does not reflect ambient light, and/or is not highly reflective, such as a material with a matte finish. In one embodiment, film 305 may correspond to a base-supporting conductive material 310 as will be described in more detail below with reference to FIG. 4A.

Antenna 300 corresponds to a loop antenna in FIG. 3A. However, it may be appreciated that other antenna configurations may be employed by antenna 300. As will be described in more detail below with reference to FIGS. 4A-4C, conductive material 310 may be deposited in and/or coupled to film 305. Antenna 300 is shown having a rectangular shape, which may correspond to the viewing area of a display device (e.g., display device 100). It may also be appreciated that antenna 300 may relate to other geometries and/or configurations. According to another embodiment, antenna 300 may include one or more of conductive elements. In that fashion, antenna 300 may be configured to receive and/or output one or more signals. In yet another embodiment, antenna 300 and/or conductive material 310 may be sized according to one or more dimensions of a surface for mounting. By way of example, dimensions of antenna 300 may correspond to a viewing area of the display device, bezel and/or support frame of a display device (e.g., display device 100). According to another embodiment, dimensions of the conductive material 310, such as length, may be based on frequencies employed for receiving and/or transmitting signals. Further the thickness of the conductive material may be based on one or more of an expected viewing distance for the display device, commercially available manufacturing abilities and cost.

According to another embodiment, antenna 300 may be embedded in one or more mask layers of a display panel. By way of example, conductive material 310 may be aligned with one or more mask wires of the display. In this embodiment, antenna 300 would not require film 305. Further, conductive material 310 may be aligned with one of mask wires and mask wire intersections of the display device. Further, thickness of conductive material 310 could be limited to the thickness of the mask wires in this embodiment.

Referring now to FIG. 3B, antenna 320 is shown according to another embodiment of antenna 300 in FIG. 3A. Antenna 300 comprises film 305 and a plurality of conductive elements 325₁₋ₙ. It may be appreciated that the conductive elements 325₁₋ₙ may be configured to each receive one or more signals independently according to one embodiment. According to another embodiment, conductive elements 325₁₋ₙ may be configured to allow for multiple-in-multiple-out (MIMO) applications. Conductive elements 325₁₋ₙ may be configured for one or more frequencies and one of simultaneous and separate receiving and/or transmitting.

Referring now to FIG. 3C, antenna 330 is shown according to another embodiment of antenna 300 in FIG. 3A. As shown in FIG. 3C, antenna 330 comprises film 335 and conductive material 340. Film 335 is depicted with a pattern for illustration of the shape of the film. It may be appreciated that film 335 may be in the shape of a rectangular ring. According to another embodiment, dimensions of antenna 330 may correspond to at least one of a bezel (e.g., bezel 110) and frame (e.g., glass frame 135) of a display device (e.g., display device 100). In that fashion, antenna 330 may be mounted to one or more of a bezel, frame, and display device in general. According to another embodiment, film 335 may be translucent to allow for images of a display device to be viewed. While film 335 is depicted as having a pattern, it may be appreciated that film 335 corresponds to a translucent material.

Referring now to FIGS. 4A-4C, graphical representations are shown of antennas according to one or more embodiments of the invention. Referring first to FIG. 4A, a side profile is shown of antenna 400 according to one embodiment of the invention. As shown in FIG. 4A, antenna 400 (e.g., antenna 300) comprises film 405 and conductive material 410. Film 405 (e.g., film 305) may relate to at least one of synthetic polymer, organic film, and glass. Film 405 may correspond to a translucent material such that antenna 400 may be mounted to a display device.

Conductive material 410 (e.g., conductive material 310) corresponds to at least one of copper, nickel copper alloy, silver and any material for transmitting and/or receiving wireless signals. Conductive material 410 may be applied to film 405 such that one or more signals may be received and/or transmitted by antenna 400. In one embodiment, thickness of conductive material 410 may be on the order of 0.5 mm to 2 mm. However, it may be appreciated that conductive material 410 may relate to other thickness values. In another embodiment, thickness of conductive material 410 may be such that conductive material 410 is visually imperceptible by users at a normal viewing distance. For example, conductive material 410 could be visible only upon close inspection of the display device which conductive material 410 is coupled to. According to another embodiment, depth of conductive material 410 may be as thin as commercially available according to another embodiment.

When applied to film 405, conductive material 410 may include one or more conductive elements. Further, antenna 400 may be applied to a display device (e.g., display device 100) such that conductive material 410 is coupled to or separated from a display device by film 405.

Referring now to FIG. 4B, antenna 415 is shown according to another embodiment of antenna 400 in FIG. 4A. As shown in FIG. 4A, antenna 415 comprises conductive material 410 deposited within film 405.

In another embodiment, antenna 415 may relate to an antenna embedded in a display panel. For example, conductive material 410 may be aligned with one or more mask wires of the display panel. In this embodiment, antenna 415 would not require film 405, however it may be appreciated that conductive material 410 could be embedded into one or more process layers of a display panel during manufacturing. Further, conductive material 410 may correspond to one of mask wires and mask wire intersections of the display device. Further, conductive material 410 may be limited to the thickness of the mask wires in this embodiment. For example, an exemplary width of conductive material 410 may be less than the transistor routings of the display panel. Conductive material 410 in this embodiment may comprise an input/output terminal (not shown in FIG. 4B) coupled to a terminal of the display device.

Referring now to FIG. 4C, antenna 420 is shown according to another embodiment of the antenna in FIG. 4A. As shown in FIG. 4C, antenna 420 comprises conductive material 410 deposited within film 405. Antenna 420 may include glare reducing layer 425 according to one embodiment. Glare reducing layer 425 may be configured to provide pleasant viewing of a display device (e.g., display device 100), reduce eyestrain, and/or sharpen displayed images. Antenna 420 may further comprise adhesive layer 430 to couple antenna 420 to a display device. Adhesive layer 430 and/or glare reducing layer 425 may relate to a translucent material according to another embodiment. In another embodiment, film 405 may be configured to provide impact absorption. It may also be appreciated that antenna 400 may include an additional layer to provide impact absorption for a display device (e.g., display device 100).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

1. An antenna configured to receive wireless signals for a display device, the antenna comprising:
a film comprised of translucent material, the film overlaying at least a portion of a viewing area of the display device;
a conductive element for receiving one or more wireless signals, the conductive element embedded in the film within the viewing area of the display device; and
a terminal configured to couple the conductive element to one or more terminals of the display device.

2. The antenna of claim 1, wherein the translucent material comprises at least one of synthetic polymer, organic film, and glass.

3. The antenna of claim 1, wherein the translucent material is configured to permit at least seventy percent transmittance of an image displayed by the display device such that normal viewing of the display device is provided.

4. The antenna of claim 1, wherein the conductive element is configured to communicate using at least one of an 802.11x standard, multiple-in-multiple-out (MIMO) standard and wireless standard in general.

5. The antenna of claim 1, wherein the conductive element overlays at least a portion of the viewing area.

6. The antenna of claim 1, further comprising glare-reducing means disposed on the film.

7. The antenna of claim 1, wherein the film comprises an adhesive layer configured to couple the film and conductive element to the display device.

8. The antenna of claim 1, wherein the conductive element is configured to be coupled to the display device by electrostatic attraction.

9. A display device comprising:
an input terminal;
a display configured to output one or more images; and
an antenna configured to receive one or more signals for the display device, wherein the antenna comprises:
a film comprised of translucent material, the film overlaying at least a portion of a viewing area of the display device;
a conductive element for receiving one or more wireless signals, the conductive element embedded in the film within the viewing area of the display device; and
a terminal configured to couple the conductive element to the input terminal.

10. The display device of claim 9, wherein the translucent material comprises at least one of synthetic polymer, organic film, and glass.

11. The display device of claim 9, wherein the translucent material is configured to permit at least seventy percent transmittance of the images displayed by the display device such that normal viewing of the display device is provided.

12. The display device of claim 9, wherein the conductive element is configured to communicate using at least one of an 802.11x standard, multiple-in-multiple-out (MIMO) standard and wireless standard in general.

13. The display device of claim 9, wherein the conductive element overlays at least a portion of the viewing area.

14. The display device of claim 9, wherein the antenna further comprises glare-reducing means disposed on the film.

15. The display device of claim 9, wherein the film comprises an adhesive layer configured to couple the film and conductive element to the display device.

16. The display device of claim 9, wherein the conductive element is configured to be coupled to the display device by electrostatic attraction.

17. A display device comprising:
an input terminal;
a display panel configured to output one or more images, wherein the display panel comprises a mask layer comprises of one or more wires; and
an antenna configured to receive one or more signals for the display device, wherein the antenna comprises:
a conductive element aligned with the one or more wires of the mask layer; and
a terminal configured to couple the conductive element to the input terminal.

18. The antenna of claim 17, wherein the conductive element is configured to communicate using at least one of an 802.11x standard, multiple-in-multiple-out (MIMO) standard and wireless standard in general.

19. The antenna of claim 17, wherein the conductive element is coupled to the mask layer in a viewing area of the display panel.

20. The antenna of claim 17, wherein the conductive element is coupled to one or more of mask wires and mask wire intersections of the mask layer.
